(19) United States
(12) Patent Application Publication
(10) Pub. No.: US 2018/0174112 A1
(43) Pub. Date: Jun. 21, 2018

(54) PHYSICAL LOCATION SCHEDULING MANAGEMENT

(71) Applicant: International Business Machines Corporation, Armonk, NY (US)

(72) Inventors: Ilse M. Breedvelt-Schouten, Manotick (CA); Jana H. Jenkins, Raleigh, NC (US); Jeffrey A. Kusnitz, Campbell, CA (US); John A. Lyons, Ottawa (CA)

(21) Appl. No.: 15/712,236

(22) Filed: Sep. 22, 2017

Related U.S. Application Data
(63) Continuation of application No. 15/387,632, filed on Dec. 21, 2016.

(51) Int. Cl. G06Q 10/10; G06Q 50/00

(52) U.S. Cl. CPC G06Q 10/1095; G06Q 50/01

(57) ABSTRACT

Disclosed aspects relate to physical location scheduling management. A meetup event having a set of parameters which includes a set of users may be detected. A set of user accessibility profile factors for the set of users may be collected. A set of location accessibility profile factors for a set of physical locations may be compiled. An appropriate physical location to hold the meetup event may be determined based on both the set of location accessibility profile factors and the set of user accessibility profile factors. The appropriate physical location to hold the meetup event may be indicated in response to determining the appropriate physical location for the meetup event.

### BACKGROUND

This disclosure relates generally to computer systems and, more particularly, relates to physical location scheduling management. Various communication networks may facilitate the scheduling of meetings between individuals and organizations. The number of electronically scheduled meetings is increasing. As the number of electronic meetings scheduled increases, the need for physical location scheduling management may also increase.

### SUMMARY

Aspects of the disclosure relate to adjusting calendar invitations based on a set of users and their accessibility requirements. A location for a meeting, practice, appointment, or the like may need to be scheduled based on individual accessibility needs of the group of attendees. A set of preferences and requirements may be collected for the set of attendees and a set of features related to possible locations may be collected. The preferences of the set of attendees may be compared with the features of the possible locations in order to select appropriate locations for the meeting. The selected location for the meeting may be communicated to each of the attendees. In this way, the location for a meeting may be automatically determined based on the needs and preferences of the users attending.

Disclosed aspects relate to physical location scheduling management. A meetup event having a set of parameters which includes a set of users may be detected. A set of user accessibility profile factors for the set of users may be collected. A set of location accessibility profile factors for a set of physical locations may be compiled. An appropriate physical location to hold the meetup event may be determined based on both the set of location accessibility profile factors and the set of user accessibility profile factors. The appropriate physical location to hold the meetup event may be indicated in response to determining the appropriate physical location for the meetup event.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a high-level block diagram of a computer system for implementing various embodiments of the present disclosure, according to embodiments.

FIG. 2 is a flowchart illustrating a method for physical location scheduling management, according to embodiments.

FIG. 3 is a flowchart illustrating a method for physical location scheduling management, according to embodiments.

FIG. 4 is a flowchart illustrating a method for physical location scheduling management, according to embodiments.

FIG. 5 is a flowchart illustrating a method for physical location scheduling management, according to embodiments.

FIG. 6 is a flowchart illustrating a method for physical location scheduling management, according to embodiments.

FIG. 7 is a flowchart illustrating a method for physical location scheduling management, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to adjusting calendar invitations based on a set of users and their accessibility requirements. A location for a meeting, practice, appointment, or the like may need to be scheduled based on individual accessibility needs of the group of attendees. A set of preferences and requirements may be collected for the set of attendees and a set of features related to possible locations may be collected. The preferences of the set of attendees may be compared with the features of the possible locations in order to select appropriate locations for the meeting. The selected location for the meeting may be communicated to each of the attendees. In this way, the location for a meeting may be automatically determined based on the needs and preferences of the users attending.

Calendar systems may invite individuals to meetup events without considering their individual accessibility needs. A physical location scheduling management engine may provide a set of users with effective, comfortable, and accessible location options while taking into account disabilities, temporary physical challenges, symptoms, and other user preferences or requirements. Individual information may be collected from profiles, social media environments, and conversations of users with respect to possible participants and appropriate physical location choices may be provided to the group of users. As an example, a user may have hurt his back and may have difficulty moving. The user may note this injury and his desired walking distance in his profile or social media information. His boss may be scheduling a meeting for tomorrow which he is expected to attend. The boss of the user may use a physical location scheduling management engine to determine possible appropriate locations for the meeting. The mobility problems of the original user may be collected from his profile and taken into consideration. The system may determine available locations which are closer to the office of the original user. The boss of the user may select an option for the location of the meeting from the set of available locations. Other examples of the method described herein may also be possible.

Aspects of the disclosure relate to a system, method, and computer program product for physical location scheduling management. A meetup event having a set of parameters which includes a set of users may be detected. A set of user accessibility profile factors for the set of users may be collected. A set of location accessibility profile factors for a set of physical locations may be compiled. An appropriate physical location to hold the meetup event may be determined based on both the set of location accessibility profile factors and the set of user accessibility profile factors. The appropriate physical location to hold the meetup event may be indicated in response to determining the appropriate physical location for the meetup event.

In embodiments, aspects of the disclosure may structure the set of accessibility profile factors to include various factors (e.g., technology, nutrition, access clearance). In certain embodiments, disclosed aspects may automatically schedule the appropriate physical location to hold the meetup event. In various embodiments, features may retrieve and analyze user social media information. In certain embodiments, disclosed aspects may compute a set of weighted candidate physical location scores for appropriate locations using a set of weighting criteria. In certain embodiments, aspects of the disclosure may rank the choices for meetup locations based on their suitability for the attendees. In certain embodiments, features may determine the appropriate physical location in a user availability independent fashion to streamline determination of an appropriate physical location. Altogether, aspects of the disclosure can have performance or efficiency benefits. Aspects may save resources such as network bandwidth, time, processing, or memory. As an example, the use of a physical location scheduling management engine may save time through the automatic collection of user accessibility profile factors and location accessibility profile factors. Through physical location scheduling management, an organizing user may save time instead of having to manually request preferences and requirements of other attendees, researching accessibility features of various locations, or traveling to a location that some individuals may not be able to easily reach. Other examples of saving time by using physical location scheduling management may also be possible.

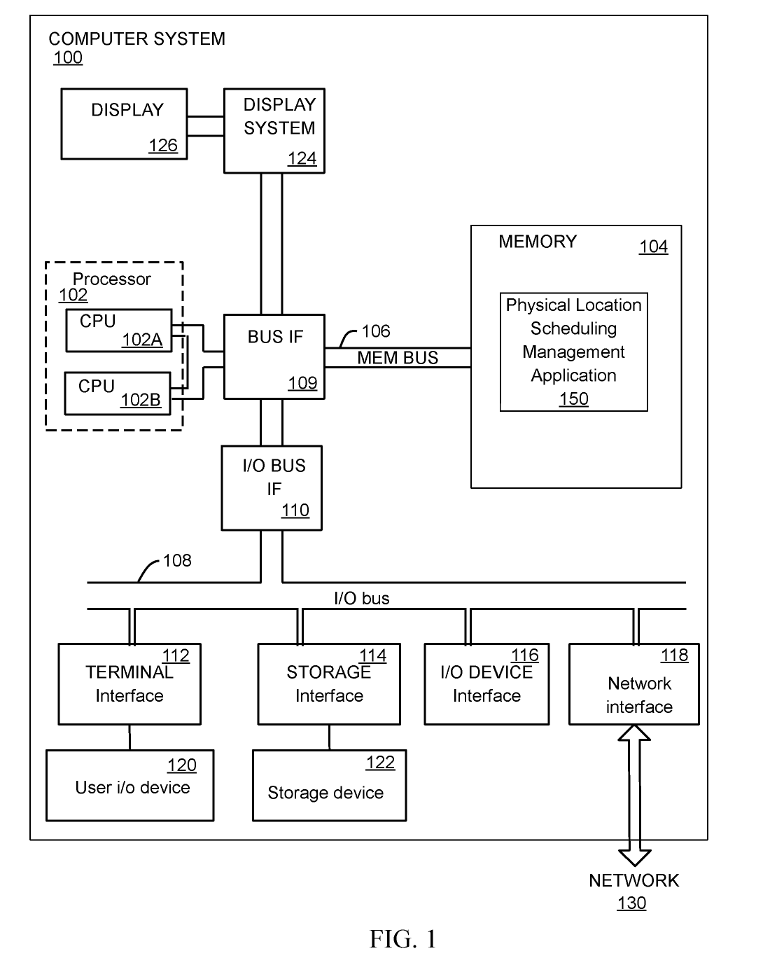

Turning now to the figures, FIG. 1 depicts a high-level block diagram of a computer system for implementing various embodiments of the present disclosure, according to embodiments. The mechanisms and apparatus of the various embodiments disclosed herein apply equally to any appropriate computing system. The major components of the computer system 100 include one or more processors 102, a memory 104, a terminal interface 112, a storage interface 114, an I/O (Input/Output) device interface 116, and a network interface 118, all of which are communicatively coupled, directly or indirectly, for inter-component communication via a memory bus 106, an I/O bus 108, bus interface unit 109, and an I/O bus interface unit 110.

The computer system 100 may contain one or more general-purpose programmable central processing units (CPUs) 102A and 102B, herein generically referred to as the processor 102. In embodiments, the computer system 100 may contain multiple processors; however, in certain embodiments, the computer system 100 may alternatively be a single CPU system. Each processor 102 executes instructions stored in the memory 104 and may include one or more levels of on-board cache.

In embodiments, the memory 104 may include a random-access semiconductor memory, storage device, or storage medium (either volatile or non-volatile) for storing or encoding data and programs. In certain embodiments, the memory 104 represents the entire virtual memory of the computer system 100, and may also include the virtual memory of other computer systems coupled to the computer system 100 or connected via a network. The memory 104 can be conceptually viewed as a single monolithic entity, but in other embodiments the memory 104 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 104 may store all or a portion of the various programs, modules and data structures for processing data transfers as discussed herein. For instance, the memory 104 can store a physical location scheduling management application 150. In embodiments, the physical location scheduling management application 150 may include instructions or statements that execute on the processor 102 or instructions or statements that are interpreted by instructions or statements that execute on the processor 102 to carry out the functions as further described below. In certain embodiments, the physical location scheduling management application 150 is implemented in hardware via semiconductor devices, chips, logical gates, circuits, circuit cards, and/or other physical hardware devices in lieu of, or in addition to, a processor-based system. In embodiments, the physical location scheduling management application 150 may include data in addition to instructions or statements.

The computer system 100 may include a bus interface unit 109 to handle communications among the processor 102, the memory 104, a display system 124, and the I/O bus interface unit 110. The I/O bus interface unit 110 may be coupled with the I/O bus 108 for transferring data to and from the various I/O units. The I/O bus interface unit 110 communicates with multiple I/O interface units 112, 114, 116, and 118, which are also known as I/O processors (IOPs) or I/O adapters (IOAs), through the I/O bus 108. The display system 124 may include a display controller, a display memory, or both. The display controller may provide video, audio, or both types of data to a display device 126. The display memory may be a dedicated memory for buffering video data. The display system 124 may be coupled with a display device 126, such as a standalone display screen, computer monitor, television, or a tablet or handheld device display. In one embodiment, the display device 126 may include one or more speakers for rendering audio. Alternatively, one or more speakers for rendering audio may be coupled with an I/O interface unit. In alternate embodiments, one or more of the functions provided by the display system 124 may be on board an integrated circuit that also includes the processor 102. In addition, one or more of the functions provided by the bus interface unit 109 may be on board an integrated circuit that also includes the processor 102.

The I/O interface units support communication with a variety of storage and I/O devices. For example, the terminal interface unit 112 supports the attachment of one or more user I/O devices 120, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 120 and the computer system 100, and may receive output data via the user output devices. For example, a user interface may be presented via the user I/O device 120, such as displayed on a display device, played via a speaker, or printed via a printer.

The storage interface 114 supports the attachment of one or more disk drives or direct access storage devices 122 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 122 may be implemented via any type of secondary storage device. The contents of the memory 104, or any portion thereof, may be stored to and retrieved from the storage device 122 as needed. The I/O device interface 116 provides an interface to any of various other I/O devices or devices of other types, such as printers or fax machines. The network interface 118 provides one or more communication paths from the computer system 100 to other digital devices and computer systems; these communication paths may include, e.g., one or more networks 130.

Although the computer system 100 shown in FIG. 1B illustrates a particular bus structure providing a direct communication path among the processors 102, the memory 104, the bus interface 109, the display system 124, and the I/O bus interface unit 110, in alternative embodiments the computer system 100 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 110 and the I/O bus 108 are shown as single respective units, the computer system 100 may, in fact, contain multiple I/O bus interface units 110 and/or multiple I/O buses 108. While multiple I/O interface units are shown, which separate the I/O bus 108 from various communications paths running to the various I/O devices, in other embodiments, some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 may be implemented as a desktop computer, portable computer, laptop or notebook computer, tablet computer, pocket computer, telephone, smart phone, or any other suitable type of electronic device.

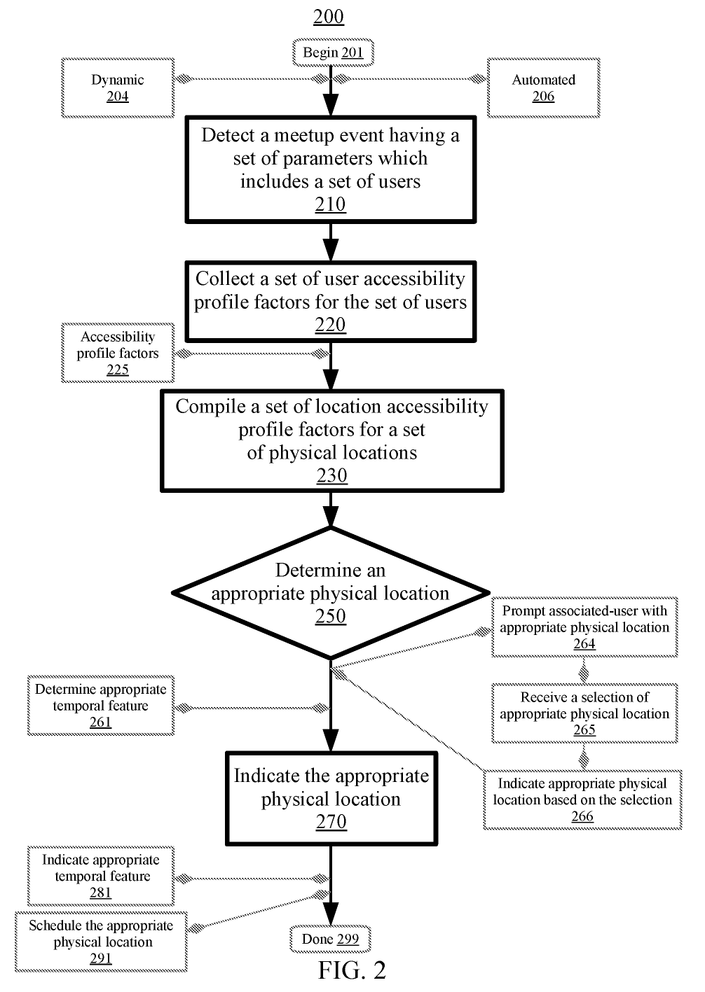

FIG. 2 is a flowchart illustrating a method 200 for physical location scheduling management, according to embodiments. Aspects of FIG. 2 relate to collecting user and location accessibility information to identify an appropriate physical location to hold a meetup event and indicate the appropriate physical location to the attendees of the meetup event. The method 200 may begin at block 201.

In embodiments, the detecting, the collecting, the compiling, the determining, the indicating, and the other steps described herein may each occur in a dynamic fashion to streamline physical location scheduling management at block 204. The detecting, the collecting, the compiling, the determining, the indicating, and the other steps described herein may be performed in real-time, ongoing, or on-the fly (e.g., the set of physical locations may be collected while the set of users for a meeting is updated in real-time, the determining may occur in a user availability independent fashion) in order to streamline (e.g., facilitate, promote) physical location scheduling management. Other methods of performing the steps described herein are also possible.

In embodiments, the detecting, the collecting, the compiling, the determining, the indicating, and the other steps described herein may each occur in an automated fashion without user intervention at block 206. The detecting, the collecting, the compiling, the determining, the indicating, and the other steps described herein may be carried out by a physical location scheduling management module without manual action or user intervention (e.g., automatically updating the set of users, automatically updating the set of candidate locations without manual intervention. In this way, aspects of physical location scheduling management may be performed using automated computer machinery without manual action. Other methods of performing the steps described herein are also possible.

At block 210, a meetup event having a set of parameters which includes a set of users may be detected. A physical location scheduling management engine (e.g., calendar application program) may perform the detection. Generally, detecting can include sensing, identifying, recognizing, discerning, discovering, or otherwise distinguishing a meetup event. The meetup event may be a request or indication of a gathering of a group of users (e.g., a corporate meeting, a meeting for a club, a meeting between healthcare professionals and patients, a casual meeting between friends, an athletic practice, a rally, a parade, a teleconference/conference call). The meetup event may have a set of parameters or numerical characteristics (e.g., invitees, number of required seats, required media/multimedia, time/date of meeting) which includes a set of users.

Consider the following example. A branch of a company may need to plan a meeting for all coworkers. The branch may use a physical location scheduling management engine to plan the meeting. The meetup event (e.g., branch meeting) may be detected by the physical location scheduling management engine. The branch meeting may have a set of parameters which may include a set of users. The set of users may include all the members of the particular branch (e.g., twenty people). The set of parameters may include a requirement of twenty seats as well as a need for a projector to display important information to the attendees. Other examples of detecting a meetup event may also be possible.

Consider the following example. A university student government association may need to plan a meeting for all members. The student government association may use a physical location scheduling management engine to plan the meeting. The meeting may be detected by the physical location scheduling management engine and include a set of parameters. The set of users may include all members of the student government association. The meeting may also be open for any university student who wishes to attend. The set of parameters may include a requirement of five seats for the members of the student government association as well as a need for a large enough meeting location to accommodate for any university student who attends. The set of parameters may also include a requirement that the meeting be held on a weekday in the evening so as not to interfere with student class schedules. Other examples of detecting a meetup event may also be possible.

At block 220, a set of user accessibility profile factors for the set of users may be collected. The physical location scheduling management engine may perform the collecting. Collecting may include acquiring, obtaining, receiving, attaining, securing, or otherwise assembling a set of user accessibility profile factors for the set of users. The set of user accessibility profile factors may include a set of characteristics which relate to necessary or desired features, configurations, arrangements, or the like for the accommodation or attendance of a user. The set of user accessibility profile factors may be specific features for a meetup event that specific users require or desire in order to attend the detected meetup event (e.g., temporal factors, technology factors, distance factors). The accessibility profile factors may be collected from each attendee of the meetup event. The accessibility profile factors may be collected in order to create a set of user accessibility profile factors for all of the users. The set of user accessibility profile factors for the set of users may assist in the determination of an accommodation for the meetup event which is appropriate for the set of users.

In embodiments, the set of accessibility profile factors may be structured at block 225. Generally, structuring can include building, assembling, formatting, organizing, or otherwise arranging the set of accessibility profile factors. The set of user accessibility profile factors may be selected from a group consisting of a technology factor. The technology factor may be a characteristic of the set of user accessibility profile factors which relates to necessary or desired computing equipment for a meetup event. The meetup event may involve technology (e.g., computers, projectors, applications) and certain attendees of the meetup may request certain equipment in order to participate. The technology factor may include a computer program (e.g., a user wants to participate in a conference call), a piece of equipment (e.g., a desire for a projector in order for a user to display a slideshow presentation), or other necessary computing equipment.

The set of user accessibility profile factors can include a distance factor. The distance factor may be a characteristic of the set of user accessibility profile factors which relates to necessary or desired travel distance for a meetup event. The meetup event may involve travel between distances (e.g., walking, driving, public transportation) and certain attendees of the meetup may not be able to travel certain distances or by certain modes of transportation. The distance factor may include an indication of the desired travel distance of a user for the meetup event (e.g., the user cannot walk more than a quarter-mile to attend a meetup, the user does not want to drive more than thirty minutes to attend a meetup), the method of travel desired by a user for a meetup event (e.g., a user requires that a meetup is within walking distance, a user desires that a meetup does not require taking public transportation, a user does not have time to fly from the east coast to the west coast for a meetup event), a problem related to travel of a user for a meetup event (e.g., a user has a broken leg and requires that the meetup be held nearby, a user does not own a car and desires that the meetup be held nearby, a user needs a wheelchair accessible path to attend a meetup), or other characteristics related to distance.

The set of user accessibility profile factors can include an elevation factor. The elevation factor may be a characteristic of the set of user accessibility profile factors which relates to necessary or desired floor-level or altitude for a meetup event. The meetup may involve different elevations, and certain attendees of the meetup may not be able to attend meetups at certain elevations. The elevation factor may include the method of travel between floor-levels desired by a user for a meetup event (e.g., a user has trouble climbing multiple flights of stairs, a user is uncomfortable in confined spaces such as elevators) or the accessibility of various floor-levels of a building for a meetup event (e.g., a user is in a wheelchair and requires an elevator/ramp). The elevation factor may include the desired altitude of a meetup event (e.g., a user experiences sickness while at high altitudes). Other accessibility profile factors related to elevation may also be possible.

The set of user accessibility profile factors can include a personal room factor. The personal room factor may be a characteristic of the set of user accessibility profile factors which relates to necessary or desired private spaces for a meetup event. Certain attendees of the meetup may desire certain personal rooms within a threshold distance/proximity in order to attend the meetup. The personal room factor may include a washroom (e.g., a user desires an on-site washroom for meetups lasting over thirty minutes), feeding room (e.g., a user frequently brings their newborn baby to meetups and requires a separate private room without going outside to another building), desired features of personal rooms (e.g., a feeding room with no windows), or other types of desired private spaces.

The set of user accessibility profile factors can include an indoor-outdoor factor. The indoor-outdoor factor may be a characteristic of the set of user accessibility profile factors which relates to necessary or desired features for a meetup event with respect to an outdoor location versus an indoor location. The meetup event may involve spaces (e.g., indoor room, outdoor area) and certain attendees of the meetup may request certain indoor or outdoor spaces in order to attend the meetup. The indoor-outdoor factor may include the actual physical location of the meeting (e.g., the user may desire to attend only meetups with an indoor location, an outdoor soccer field is required for practice), the indoor or outdoor location of travel to the meeting (e.g., a user may desire to avoid meetups that require outdoor travel via icy sidewalks), features related to weather and temperature (e.g., the baseball field is covered in snow so an indoor facility is needed for practice), or other characteristics related to indoor and outdoor environments.

The set of user accessibility profile factors can include an access clearance factor. The access clearance factor may be a characteristic of the set of user accessibility profile factors which relates to necessary or desired security clearance levels of a user for a meetup event. The meetup event may involve clearance levels (e.g., full access, partial access) and certain attendees of the meetup may request certain levels of security clearance in order to participate in the meetup. The access clearance factor may include access credentials (e.g., a user does not have an identification badge to access all locations within a secure building), required vehicles (e.g., a user does not have access to a company-owned vehicle which may be necessary to receive access to a location), required communication devices (e.g., a user desires meetups in locations which allow the use of a personal cell phone instead of requiring a work cell phone/not allowing a cell phone), guest allowance (e.g., a user requires a location which allows guide dogs, a user desires to bring another person with a lower level of access clearance), or other characteristics related to security.

The set of user accessibility profile factors can include a computing configuration factor. The computing configuration factor may be a characteristic of the set of user accessibility profile factors which relates to necessary or desired settings or arrangements of computing equipment for a meetup event. The meetup event may involve technology (e.g., computers, projectors, applications) and certain attendees of the meetup may request certain computer configurations of involved technology in order to participate. Computing configuration information may be automatically collected from the settings of computing equipment. The computing configuration factor may include settings related to visual components (e.g., a user desires computing equipment which is configured to increase the font size due to a visual impairment), settings related to audio components (e.g., a user requires computing equipment which is configured for the hearing impaired), settings related to available applications (e.g., a user desires computing equipment which includes a video chat application in order to attend the meetup remotely), or other characteristics related to computing configurations.

The set of user accessibility profile factors can include an environmental sensitivity factor. The environmental sensitivity factor may be a characteristic of the set of user accessibility profile factors which relates to necessary or desired natural characteristics of a location for a meetup event. The meetup event may take place in various environments (e.g., laboratories, outdoors) and certain attendees of the meetup may desire certain environmental factors in order to participate. The environmental sensitivity factor may include exposure to allergens (e.g., a user has a severe pollen allergy and requires an indoor meeting), room temperature (e.g., a user desires a room temperature at a meetup of exactly seventy-two degrees), exposure to chemicals (e.g., a user is sensitive to a particular chemical and cannot meet in certain laboratory locations), air flow (e.g., a user desires a meetup location with windows that can be opened), light (e.g., a user suffers from headaches from fluorescent lighting), or other characteristics related to environmental sensitivities (e.g., new carpet or fresh paint in a room which relate to potential allergic or chemical responses).

The set of user accessibility profile factors can include a nutrition factor. The nutrition factor may be a characteristic of the set of user accessibility profile factors which relates to necessary or desired nutritional characteristics of food items at a meetup event. The meetup event may involve food items (e.g., a potluck, a luncheon, in a location that permits snacks) and certain attendees of the meeting may not be able to experience exposure to particular food items. Nutritional information may be automatically collected from a nutrition calendar or application (e.g., weight-loss application, food-tracking application). The nutritional factor may include food allergies (e.g., a user has a gluten intolerance, a user is allergic to peanuts), food preferences (e.g., a user does not like seafood, a user does not eat meat), recommended food items based on nutritional applications (e.g., a user frequently drinks coffee around 10 A.M., a user indicates a preference for pasta dishes), dietary information regarding a set of users (e.g., several users attending the meetup are vegetarians, a user is following the paleo diet), or other characteristics related to nutrition.

The set of user accessibility profile factors can include an illness status factor. The illness status factor may be a characteristic of the set of user accessibility profile factors which relates to a necessary or desired health and wellness level for a meetup event. The meetup event may involve other attendees, and certain attendees of the meetup may require certain levels of health in order to participate. The illness status factor may include an illness (e.g., a user is currently suffering from the flu), an injury (e.g., a user is suffering from a concussion and cannot look at bright screens, a user has a broken leg and is in a wheelchair), a level of health (e.g., a user suffers from an immune system deficiency and cannot be around other attendees who are ill), or other characteristics related to health and wellness.

Consider the following example. A healthcare professional may need to schedule a meeting with a patient and family members of a patient. The healthcare professional (e.g., doctor) may use a physical location scheduling management engine. The physical location scheduling management engine may detect the meeting with the patient and family members. The physical location scheduling management engine may collect a set of user accessibility profile factors for the set of users (e.g., the doctor, the patient, the family members). The set of user accessibility profile factors may include a technology factor. One of the family members may not be able to travel to the meetup event and may require a video chat application in order to participate in the meetup. The set of user accessibility profile factors may include a distance factor. The patient may be using crutches to walk and it may be difficult for the patient to travel long distances on foot. The set of user accessibility profile factors may include an elevation factor. The patient on crutches may have difficulty navigating via staircase. The set of user accessibility profile factors may include a personal room factor. The patient may need a washroom which includes handicap accessible features (e.g., a support railing, large enough to accommodate a wheelchair). The set of user accessibility profile factors may include an indoor-outdoor factor. There may be ice on the ground and it may be easier for the patient on crutches to attend a meetup which does not require outdoor travel. The set of user accessibility profile factors may include an access clearance factor. Certain locations in the hospital may be available to healthcare professionals only, and the patient and family members may not have the appropriate level of clearance to access these areas. The set of user accessibility profile factors may include a computing configuration factor. A family member of the patient may be legally blind, and may require certain computing equipment in order to fully participate in the meetup event. The set of user accessibility profile factors may include an environmental sensitivity factor. The patient may be severely allergic to certain medications that may be stored in various rooms of the hospital. The set of user accessibility profile factors may include a nutrition factor. A family member of the patient may have a severe food allergy to shellfish which may be served in the hospital cafeteria. The set of user accessibility profile factors may include an illness status factor. The patient may have an immune system deficiency and needs to be kept isolated from other patients who have contagious illnesses. Other examples of collecting a set of user accessibility profile factors may also be possible.

At block 230, a set of location accessibility profile factors for a set of physical locations may be compiled. The physical location scheduling management engine may perform the compiling. Generally, compiling may include generating, arranging, assembling, creating, organizing, collecting, or otherwise gathering a set of location accessibility profile factors for a set of physical locations. The set of location accessibility profile factors may be a set of characteristics which relate to features, configurations, arrangements, or the like of a specific meetup location (e.g., room, floor, building, environment). The set of location accessibility profile factors may correspond to, be similar to, or be the same as the set of user accessibility profile factors. The set of location accessibility profile factors may be specific features of a location or space related to various accessibility factors, such as a technology factor (e.g., the location has a projector, the location has equipment for a conference call), a distance factor (e.g., the location is far away from several attendees, the location is within walking distance), an elevation factor (e.g., the location is on the tenth floor, the location is accessible only via staircase), a personal room factor (e.g., the location has multiple washrooms, the location does not have a feeding room), an indoor-outdoor factor (e.g., the location is indoors, the location requires travel via a slippery staircase), an access clearance factor (e.g., a location requires an identification badge in order to be accessed, a location does not allow guide dogs), a computing configuration factor (e.g., a location is not configured for the visually impaired, a location is configured for the hearing impaired), an environmental sensitivity factor (e.g., the temperature of the location cannot be manually adjusted, several dangerous chemicals may be stored in a location), a nutrition factor (e.g., the food at a location is not gluten-free, the food at a location is safe for attendees with shellfish allergies), an illness status factor (e.g., a location is easily accessible for attendees using crutches), or other location accessibility factors. The accessibility profile factors may be collected for each location. The accessibility profile factors may be collected in order to create a set of location accessibility profile factors for the set of locations. The set of location accessibility profile factors may assist in the determination of an accommodation for the meetup event which is appropriate for the set of users.

Consider the following example. A group of friends may want to schedule a lunch meetup before the holidays. A set of user accessibility profile factors may be collected for the group of friends (e.g., a distance factor indicating that the friends live in different states, an indoor-outdoor factor indicating that the friends wish to have lunch indoors due to the cold weather, a nutrition factor indicating that one of the friends has a gluten allergy). A set of location accessibility profile factors may be collected for the set of physical locations for the lunch meetup. The set of location accessibility profile factors may include a distance factor. The friends may live in different states and a location should be chosen such that the friends will travel a relatively equal distance to attend the lunch meetup. Restaurants which are relatively equidistant from all the friends may be considered for the meetup. The set of location accessibility profile factors may include an indoor-outdoor factor. The weather may be cold, and the friends may desire to eat lunch at an indoor restaurant. Restaurants which include indoor seating may be considered for the meetup. The set of location accessibility profile factors may include a nutrition factor. One of the friends may have a severe gluten allergy and may need to eat at a restaurant with gluten-free options. Restaurants which have gluten-free menu options may be considered for the meetup event.

At block 250, an appropriate physical location to hold the meetup event may be determined based on both the set of location accessibility profile factors and the set of user accessibility profile factors. Generally, determining may include resolving, selecting, computing, formulating, generating, or otherwise ascertaining an appropriate (e.g., suitable, satisfactory, meets the criteria, best available, highest ranked) physical location to hold the meetup event. The set of location accessibility profile factors and the set of user accessibility profile factors may be analyzed, compared, mapped, evaluated, or examined in order to determine an appropriate physical location for the meetup. Specific locations may include location accessibility profile factors (e.g., a building has rooms which are accessible without having to use a staircase) which accommodate for user accessibility profile factors (e.g., a user is in a wheelchair/unable to climb staircases) and these specific locations may be more appropriate locations to hold the meetup event (e.g., this location may be determined appropriate for the meetup). Locations with location accessibility profile factors (e.g., rooms are only accessible via staircase) which do not accommodate for user accessibility profile factors (e.g., a user is in a wheelchair) may be ignored or filtered-out (e.g., this location may not be determined appropriate for the meetup).

Consider the following example. A soccer team may want to schedule a team practice using a physical location scheduling management engine. A set of user accessibility profile factors for the players and coaches may be collected. The set of user accessibility profile factors may include a distance factor. Players and coaches may live in different towns and may need to travel by car to attend practice. The set of user accessibility profile factors may include an indoor-outdoor factor. An outdoor soccer facility or field may be required for this practice. The set of user accessibility profile factors may include a personal room factor. The players may need a facility which includes access to a locker room, changing room, or equipment storage room. A set of location accessibility profile factors for the set of locations may be compiled. Location A may be a convenient travel distance for the set of players and coaches but may not include a soccer field or locker room. Location B may be an inconvenient travel distance for the set of players and coaches but may include a soccer field and accessible locker room. Location C may be a convenient travel distance for the set of players and coaches and may include an outdoor soccer field with locker room and equipment storage room. Location C may be determined as an appropriate physical location to hold soccer practice based on the user accessibility profile factors (e.g., desired equal distance, requirement of an outdoor soccer field, requirement of a private locker room) and the location accessibility profile factors (e.g., convenient travel distance, outdoor soccer field, private locker room/equipment storage room access). Other methods of determining an appropriate physical location for the meetup event may also be possible.

At block 270, the appropriate physical location to hold the meetup event may be indicated in response to determining the appropriate physical location for the meetup event. Generally, indicating may include designating, specifying, providing, presenting, or otherwise displaying the appropriate physical location to hold the meetup event. The indication of the appropriate physical location may be based on an automated (e.g., without user intervention) selection of the appropriate physical location. The indication may include an email notification, a calendar application notification, a text message, a graphical presentation/display, or other types of notifications.

Consider the following example. A group of users at a branch of a company may need to plan a meeting with a coworker at a different branch in a different location using a physical location scheduling management engine. The meeting may need to be a teleconference due to the multiple locations of the users. A set of user accessibility profile factors may be collected, including a technology factor (e.g., requirement of a projector screen) and a computing configuration factor (e.g., requirement of a teleconferencing application on a computing device). A set of location accessibility profile factors may be compiled, including a technology factor (e.g., the two conference rooms at the branch each have a projector) and a computing configuration factor (e.g., only Conference Room A has a computing device configured to include a teleconferencing application). An appropriate physical location for the teleconference may be determined based on both the set of user accessibility profile factors and the set of location accessibility profile factors. Conference Room A may be determined as an appropriate physical location for the teleconference because it includes both a projector and a teleconferencing application. Conference Room A may be indicated as the appropriate location for the teleconference. An email may be sent to the coworkers participating in the teleconference indicating that the meeting will be held in Conference Room A. Other examples of indicating the appropriate physical location to hold the meetup event may also be possible.

In embodiments, an appropriate temporal feature for the meetup event may be determined based on both the set of location accessibility profile factors and the set of user accessibility profile factors at block 261. Determining may include resolving, ascertaining, identifying, deriving, or otherwise extracting an appropriate temporal feature for the meetup event. The appropriate temporal feature may be a characteristic of a meetup which relates to a time period. The appropriate temporal feature may be a time of day (e.g., afternoon, morning), a start time (e.g., 9:30 A.M.), an end time (e.g., 5 P.M.), a duration (e.g., two hours), or other aspects related to time. The appropriate temporal feature for the meetup event may be determined through the analysis, comparison, mapping, evaluating, or examination of the set of location accessibility profile factors and the set of user accessibility profile factors. Specific locations may present challenges based on the time of day (e.g., noise, traffic, trains, public transportation schedules, scent/allergens in the air, laboratory testing). Some locations may be more appropriate during different temporal periods.

In embodiments, the appropriate temporal feature for the meetup event may be indicated in response to determining the appropriate temporal feature for the meetup event at block 281. Indicating may include specifying, identifying, detailing, or otherwise tagging the appropriate temporal feature for the meetup event. The appropriate temporal feature may be indicated along with the indication of the appropriate physical location in the same email, calendar event, text message, or the like.

Consider the following example. The science club at a university may need to schedule their monthly meeting using a physical location scheduling management engine. A set of user accessibility profile factors may be collected. The set of user accessibility profile factors may include a distance factor. Some members of the science club may not have a car on campus and may need to walk to the meeting location. The set of user accessibility profile factors may include an illness status factor. One of the members may have broken their leg and be confined to a wheelchair. The set of user accessibility profile factors may include an environmental sensitivity factor. One of the members may have a sensitivity to a particular chemical. The set of location accessibility profile factors may be compiled. Room A may not be wheelchair accessible despite being within walking distance for members. Room B may be within walking distance and be wheelchair accessible, but may be the chemistry lab. Room C may be within walking distance, wheelchair accessible, and not used as storage for chemicals. Room C may be determined as the appropriate physical location for the science club meeting. An appropriate temporal feature for the meeting may be determined based on the set of user and location accessibility profile factors. As an example, the meeting may need to be held in the evening so as not to conflict with the class schedules of the attendees. Chemical testing may occur in rooms nearby Room C on Thursdays, so the meeting may need to be held on Wednesday to avoid chemical sensitivity issues for attendees. The appropriate temporal feature for the science club meeting may be 7:00 P.M. on Wednesday. The appropriate temporal feature for the meeting may be indicated. An email may be sent to the members of the science club indicating the appropriate location (e.g., Room C) and the appropriate temporal feature (e.g., Wednesday at 7:00 P.M.) for the science club meeting. Other examples of determining and indicating an appropriate temporal feature for a meetup event may also be possible.

In embodiments, an associated-user may be prompted with the appropriate physical location to hold the meetup event at block 264. An associated-user may be prompted by the physical location scheduling management engine in response to determining the appropriate physical location for the meetup event. Generally, prompting may include providing, supplying, or otherwise presenting an associated-user with the appropriate physical location and/or the appropriate temporal feature to hold the meetup event. The associated-user may be automatically prompted with the appropriate physical location to hold the meetup event via a graphical user interface, an email, a calendar system interface, a text message alert, or other methods of prompting the associated-user with an alert. The associated-user may be an organizing user (e.g., boss, club leader), a participant user (e.g., colleague, member), a scheduling user, an administrative assistant user, or other types of users.

In embodiments, a selection of the appropriate physical location to hold the meetup event may be received by the physical location scheduling management engine from the associated-user at block 265. The selection of the appropriate physical location to hold the meetup event may be received in response to prompting the associated-user with the appropriate physical location to hold the meetup event. Generally, receiving can include acquiring, gathering, attaining, or otherwise obtaining a selection of the appropriate physical location to hold the meetup event. The associated-user may select, choose, or otherwise determine the appropriate physical location of the meetup event. The selection may be received by the physical location scheduling management engine. The selection may include an affirmative selection by the user of the appropriate physical location (e.g., a computer receives an explicit choice of a button, a computer senses an alert of an indicated location) or a passive selection (e.g., the appropriate physical location was populated as the location value and the user sent out the meetup notice). The selection of the appropriate physical location may occur by the associated-user and not in an automated fashion.

In embodiments, the appropriate physical location to hold the meetup event may be indicated at block 266. The appropriate physical location to hold the meetup event may be indicated both based on and in response to receiving the selection of the appropriate physical location to hold the meetup event. Indicating may include designating, specifying, providing, displaying, or otherwise presenting the appropriate physical location to hold the meetup event as described herein. The selection of the appropriate physical location by the associated-user and not in an automated fashion may result in the appropriate physical location to hold the meetup being indicated. The indication may include an email notification, a calendar application notification, a text message, or other types of notifications.

Consider the following example. The chief executive officer of a corporation may want to schedule a conference with the various department heads by using a physical location scheduling management engine. User accessibility profile factors and locations accessibility profile factors may be collected and an appropriate location for the conference may be determined (e.g., the private office space of the CEO). An associated-user may be prompted with the physical location for the meeting. The associated-user in this example may be the personal assistant of the CEO. The personal assistant may be presented with an email indicating that the private office of the CEO is the determined appropriate location for the conference. The physical location scheduling management engine may receive a selection of the private office space for the conference from the personal assistant. As an example, the personal assistant may type “CONFIRM” into a reply entry space in the email indicating the location. As another example, the selection by the personal assistant may not include an affirmative selection/operation. The personal assistant may forward the email to the attendees of the conference without making any changes to the location. The selection (e.g., not making any changes before sending the information) may be received by the physical location scheduling management engine. The appropriate physical location (e.g., private office space of the CEO) may be indicated. An email may be sent to each department head indicating (e.g., noting, specifying) the determined location for the conference. Other methods of indicating an appropriate physical location via an associated-user may also be possible.

In embodiments, the appropriate physical location to hold the meetup event may be scheduled by the physical location scheduling management engine at block 291. The appropriate physical location to hold the meetup event may be scheduled in response to determining the appropriate physical location for the meetup event. Generally, scheduling can include sending, planning, or otherwise arranging the appropriate physical location to hold the meetup event. The scheduling may occur in an automated fashion without manual intervention. Scheduling may include transmitting a data packet to an external system which organizes physical locations for meetup events (e.g., room reservation program, campus room registry calendar application). Scheduling may include sending a message to all attendees of a meetup event (e.g., indicating the meetup on the calendar application of all attendees). The scheduling of the appropriate physical location may indicate to all users, not just the associated-user, the location and time of a meetup event.

Consider the following example. A patient may need to schedule an appointment with their healthcare professional (e.g., dentist). Based on the user accessibility profile factors and location accessibility profile factors, a physical location for the dentist appointment may be determined. Appointment Room C may be determined as the appropriate physical location for the appointment as opposed to Appointment Rooms A, B, D, or E. The physical location scheduling management engine may schedule Appointment Room C as the location for this appointment. A message may be sent to the appointment reservation calendar application of the dentist office. The calendar application may indicate an appointment for this specific patient at a particular time (e.g., 9:30 A.M.). A message may be automatically sent to the room reservation program used by the dentist office. The program may indicate that Appointment Room C is now unavailable during a certain time period (e.g., from 9:15 A.M. to 10:45 A.M.). A message may be sent to the calendar application of the patient. The calendar application on the smartphone of the patient may create a calendar event for the dentist appointment and indicate that the appointment will be held at 9:30 A.M. in Appointment Room C. Other methods of scheduling an appropriate location for the meetup event may also be possible.

Method 200 concludes at block 299. Aspects of method 200 may provide performance or efficiency benefits for physical location scheduling management. Aspects may save resources such as network bandwidth, time, processing, or memory. As an example, the scheduling of the appropriate physical location to hold the meetup event may occur in an automated fashion without user intervention, which may save time. The associated-user may not have to manually add the meetup to the calendar planning application for the location or the individual calendar applications of the attendees. Other methods of saving processing time may also be possible.

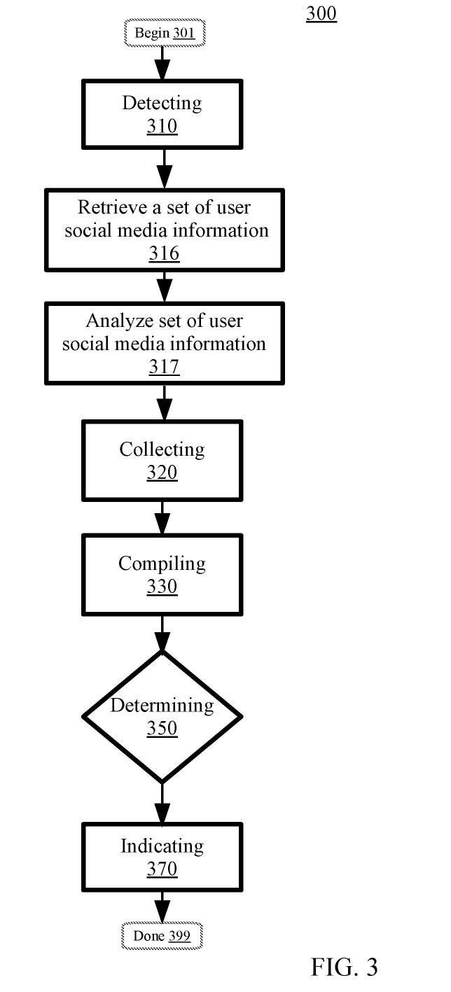

FIG. 3 is a flowchart illustrating a method 300 for physical location scheduling management, according to embodiments. Aspects of method 300 may be similar or the same as aspects of method 200, and aspects may be utilized interchangeably with one or more methodologies described herein. The method 300 may begin at block 301. At block 310, a meetup event having a set of parameters which includes a set of users may be detected by a physical location scheduling management engine. At block 320, a set of user accessibility profile factors for the set of users may be collected by the physical location scheduling management engine. At block 330, a set of location accessibility profile factors for a set of physical locations may be compiled by the physical location scheduling management engine. At block 350, an appropriate physical location to hold the meetup event may be determined based on both the set of location accessibility profile factors and the set of user accessibility profile factors. At block 370, the appropriate physical location to hold the meetup event may be indicated in response to determining the appropriate physical location for the meetup event.

In embodiments, a set of user social media information for the set of users may be retrieved by the physical location scheduling management engine at block 316. Generally, retrieving can include acquiring, gathering, fetching, aggregating, or otherwise accumulating a set of user social media information for the set of users. The set of user social media information may include email conversations, social media dialogues, photographs, past meetup location preferences, calendar events, social networking profile information, or other information which may indicate accessibility factors for the set of users.

In embodiments, the set of user social media information for the set of users may be analyzed to collect the set of user accessibility profile factors for the set of users at block 317. Analyzing may include evaluating, examining, resolving, querying, or otherwise categorizing the set of user social media information for the set of users. The set of social media information may be analyzed using natural language processing including analysis of keywords, hashtags, mentions, or other natural language elements. The set of social media information for the set of users may indicate or specify certain user accessibility profile factors which may help determine an appropriate physical location for a meetup event. As an example, the social media information of a specific user may indicate a visual impairment. The set of user accessibility profile factors for this user may include a computing configuration factor which indicates that technology should be configured in such a way to allow this user to view material via the technology, a distance factor which indicates that the user may have difficulty driving long distances due to their visual impairment, and an access clearance factor which indicates that the user may need a level of clearance which permits a guide dog.

Consider the following example. A group of friends may want to schedule a meetup event (e.g., luncheon at a restaurant) for a birthday celebration using a physical location scheduling management engine. A set of user social media information for the group of friends may be retrieved. Friend A and Friend B may indicate their hometowns via a social networking profile. Friend C may send several messages regarding their vegan diet. Friend D may send an email which indicates that the user has recently been confined to a wheelchair. The set of social media information for these four users may be analyzed in order to collect the set of user accessibility profile factors for the group. The set of user accessibility profile factors may include a distance factor. Friend A and B may live an hour apart from one another, and may wish to choose a physical location for the luncheon which is equidistant from their homes. The set of user accessibility profile factors may include a nutrition factor. The menu at the determined restaurant may need to include vegan options for Friend C. The set of user accessibility profile factors may include an elevation factor. The selected restaurant may need to be located on the ground floor of the building. A restaurant may be selected for the birthday celebration which is approximately the same distance from Friends A and B, includes vegan options, and is wheelchair accessible. Other methods of retrieving and analyzing social media information to determine an appropriate physical location for a meetup may also be possible.

Method 300 concludes at block 399. Aspects of method 300 may provide performance or efficiency benefits for physical location scheduling management. Aspects may save resources such as network bandwidth, time, processing, or memory. As an example, processing time may be saved through the use of social media information to collect the set of user accessibility profile factors. The set of social media information for a user may be collected automatically and may prevent the user from having to input the user accessibility profile factors manually. Other methods of saving processing time may also be possible.

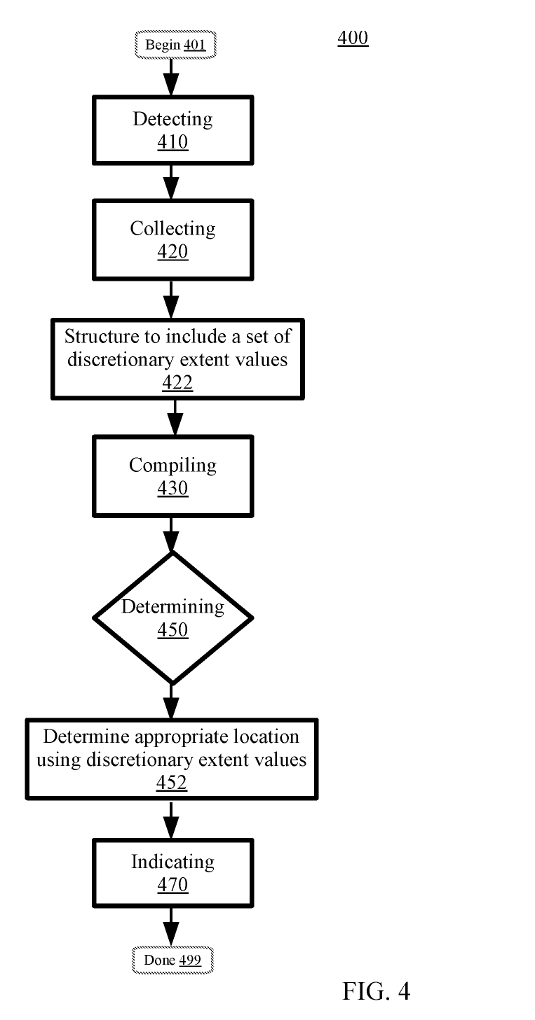

FIG. 4 is a flowchart illustrating a method 400 for physical location scheduling management, according to embodiments. Aspects of method 400 may be similar or the same as aspects of method 200/300, and aspects may be utilized interchangeably with one or more methodologies described herein. The method 400 may begin at block 401. At block 410, a meetup event having a set of parameters which includes a set of users may be detected by a physical location scheduling management engine. At block 420, a set of user accessibility profile factors for the set of users may be collected by the physical location scheduling management engine. At block 430, a set of location accessibility profile factors for a set of physical locations may be compiled by the physical location scheduling management engine. At block 450, an appropriate physical location to hold the meetup event may be determined based on both the set of location accessibility profile factors and the set of user accessibility profile factors. At block 470, the appropriate physical location to hold the meetup event may be indicated in response to determining the appropriate physical location for the meetup event.

In embodiments, the set of user accessibility profile factors for the set of users may be structured to include a set of discretionary extent values at block 422. The set of discretionary extent values may indicate one or more degrees of consideration with respect to one or more user accessibility profile factors. Generally, structuring may include arranging, organizing, constructing, configuring, or otherwise assembling the set of user accessibility profile factors to include a set of discretionary extent values. The set of discretionary extent values may include options which may indicate one or more degrees of consideration with respect to one or more user accessibility profile factors. The set of discretionary extent values may include options to indicate a required, necessary, preferred, optional, or alternative accessibility factor. The set of discretionary extent values may indicate to what extent a respective user accessibility profile factor is necessary. As an example, a user may want a meeting to be within walking distance, but the user may be able to travel to a meeting by car if necessary. The user accessibility profile factor of this particular user is not necessary and is merely desired. The discretionary extent value of the distance factor may be indicated.

In embodiments, the appropriate physical location to hold the meetup event may be determined using the set of discretionary extent values at block 452. Determining may include resolving, ascertaining, computing, or otherwise generating the appropriate physical location to hold the meetup event. The determination may be based on the set of discretionary extent values. The appropriate physical location may be determined based on the enforcement of requirements and the advising of preferences. Required user accessibility profile factors may be urgent (e.g. a user has a severe gluten allergy). Physical locations which accommodate for these requirements (e.g., a restaurant with gluten-free food items) may be considered for the meetup event. Preferred user accessibility profile factors may not be as urgent (e.g., a user prefers gluten-free food but does not have a gluten allergy). Physical locations which accommodate for these requirements (e.g., a gluten-free menu) may be considered, but the physical location for the meetup event may not be limited to the preferences of a user (e.g., the preferences of the user are not urgent). Physical locations which do not accommodate (e.g., a restaurant without a gluten-free menu) for these preferences may also be considered.

Consider the following example. A company may be selecting a location for their annual Christmas party using a physical location scheduling management engine. The set of user accessibility profile factors may be collected for the group of coworkers at this company. The set of user accessibility profile factors may include a distance factor (e.g., the desire for a restaurant which is within a twenty-minute drive from the office building), a personal room factor (e.g., one coworker needs to bring their infant to the party and requires a private feeding room), and a nutrition factor (e.g., one coworker does not like eating seafood, one coworker is severely allergic to peanuts). The set of user accessibility profile factors may be structured to include a set of discretionary extent values which indicate one or more degrees of consideration for each user accessibility profile factor. The distance factor (e.g., twenty-minute drive or less) may be considered important, but not necessary, and may be awarded a discretionary extent value of 6 on a scale from 1 through 10. The personal room factor (e.g., private feeding room) may be considered necessary and may be awarded a discretionary extent value of 9. Each nutrition factor may be awarded a discretionary extent value. The desire of one coworker to avoid seafood may be nonessential and may be awarded a value of 2. The severe peanut allergy of the other coworker may be considered urgent and may be awarded a value of 10. The discretionary extent values for the user accessibility profile factors may be used to determine a restaurant for the Christmas party. An oyster bar may be selected which is slightly farther than a twenty-minute drive from the office building since the travel time and anti-seafood preferences of one coworker are nonessential to the selection of the appropriate location. The oyster bar may include a private feeding room as well as a peanut-free menu since these factors are necessary for some of the coworkers attending the party. Other methods of determining an appropriate physical location using a set of discretionary extent values may also be possible.

Method 400 concludes at block 499. Aspects of method 400 may provide performance or efficiency benefits for physical location scheduling management. Aspects may save resources such as network bandwidth, time, processing, or memory. As an example, bandwidth may be saved through the automatic determination of an appropriate physical location to hold the meetup event. In order to accommodate for the user accessibility factors of attendees (e.g., allergies, handicaps), an associated-user may have to waste bandwidth searching for an appropriate location for a meeting (e.g., a location which accommodates for allergies of attendees, a location that has a wheelchair ramp). Other methods of saving bandwidth may also be possible.

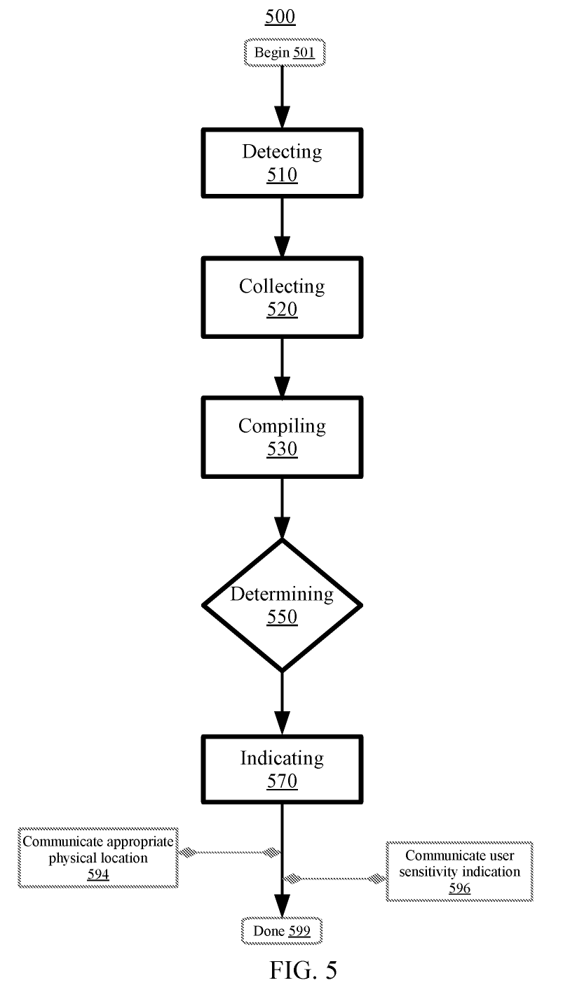

FIG. 5 is a flowchart illustrating a method 500 for physical location scheduling management, according to embodiments. Aspects of method 500 may be similar or the same as aspects of method 200/300/400, and aspects may be utilized interchangeably with one or more methodologies described herein. The method 500 may begin at block 501. At block 510, a meetup event having a set of parameters which includes a set of users may be detected by a physical location scheduling management engine. At block 520, a set of user accessibility profile factors for the set of users may be collected by the physical location scheduling management engine. At block 530, a set of location accessibility profile factors for a set of physical locations may be compiled by the physical location scheduling management engine. At block 550, an appropriate physical location to hold the meetup event may be determined based on both the set of location accessibility profile factors and the set of user accessibility profile factors. At block 570, the appropriate physical location to hold the meetup event may be indicated in response to determining the appropriate physical location for the meetup event.

In embodiments, the appropriate physical location to hold the meetup event may be communicated by the physical location scheduling management engine at block 594. Generally, communicating can include sending, transmitting, routing, publishing, or otherwise conveying the appropriate physical location to hold the meetup event. The appropriate physical location may be communicated to the set of users or a portion of the set of users. The communicating of the appropriate physical location may occur in conjunction with or separate from the indication of the appropriate physical location. The communication of the appropriate physical location may occur via sending a text message, sending an email, publishing on a social networking group page, transmitting through a calendar application, or other methods of communication.

Consider the following example. A basketball team may be scheduling a practice using a physical location scheduling management engine. Based on a set of user accessibility profile factors (e.g., players must practice indoors, the location must be no more than thirty minutes from any player) and a set of location accessibility profile factors (e.g., the gym at a school is indoors but is an hour away from three of the players, the gym at a community center is indoors and is within a half-hour from almost all the players), an appropriate location for the basketball practice may be determined (e.g., the community center). The appropriate physical location may be communicated to the set of users (e.g., players and coaches) by the physical location scheduling management engine. The players may be informed of the location of practice via an email or text message. The physical location scheduling management engine may automatically post the location of the practice to the social networking group page for the basketball team. The calendar applications of the coaches may automatically indicate the location of the practice. Other methods of communicating the appropriate physical location to hold the meetup may also be possible.

In embodiments, a user sensitivity indication may be communicated with respect to the meetup event at block 596. A user sensitivity indication may be communicated by the physical location scheduling management engine based on the set of user accessibility profile factors. Generally, communicating can include sending, transmitting, routing, publishing, or otherwise conveying a user sensitivity indication. A user sensitivity indication may be communicated to the set of users or a portion of the set of users. The communicating of a user sensitivity indication may occur in conjunction with or separate from the indication of the appropriate physical location. The communication of a user sensitivity indication may occur via sending a text message, sending an email, publishing on a social networking group page, transmitting through a calendar application, or other methods of communication. The user sensitivity indication may be a cautionary or warning message which communicates to the attendees of a meetup event that an individual on the invitee list may be associated with an accessibility factor. The user sensitivity message may include steps or measures other attendees can take in order to accommodate for the sensitivity of another attendee. As an example, a user may have a sensitivity to certain scents, such as perfumes. The user sensitivity indication may request that other attendees refrain from wearing perfumes to the meetup event.

Consider the following example. An organization may be planning a parade using a physical location scheduling management engine. A set of user accessibility factors may be collected with respect to the users planning to attend the parade. Some of the users may indicate a severe nut allergy as part of a nutrition factor. Other users may have a sensitivity to certain chemicals found in perfumes. An appropriate location (e.g., street) for the parade may be determined and this location may be communicated to the participants attending the parade. A user sensitivity indication may be communicated along with the indication of the street for the parade. The user sensitivity indication may warn the set of participants about the nut allergies of other participants as well as the sensitivity to perfumes of other participants. A warning message may be communicated to the participants (e.g., “Please do not bring food items containing nuts!”, “Avoid wearing strong perfumes.”). Through the communication of the user sensitivity indication, other participants may know in advance of the parade to be considerate regarding the allergies and sensitivities of other participants. Other examples of communicating a user sensitivity indication may also be possible.

Method 500 concludes at block 599. Aspects of method 500 may provide performance or efficiency benefits for physical location scheduling management. Aspects may save resources such as network bandwidth, time, processing, or memory. As an example, bandwidth may be saved through the communication of a user sensitivity indication in conjunction with the indication of a physical location for the meetup event. The user sensitivity indication and the physical location indication may occur within the same message, which may prevent a user from wasting bandwidth by viewing or searching for multiple messages. Other methods of saving bandwidth may also be possible.

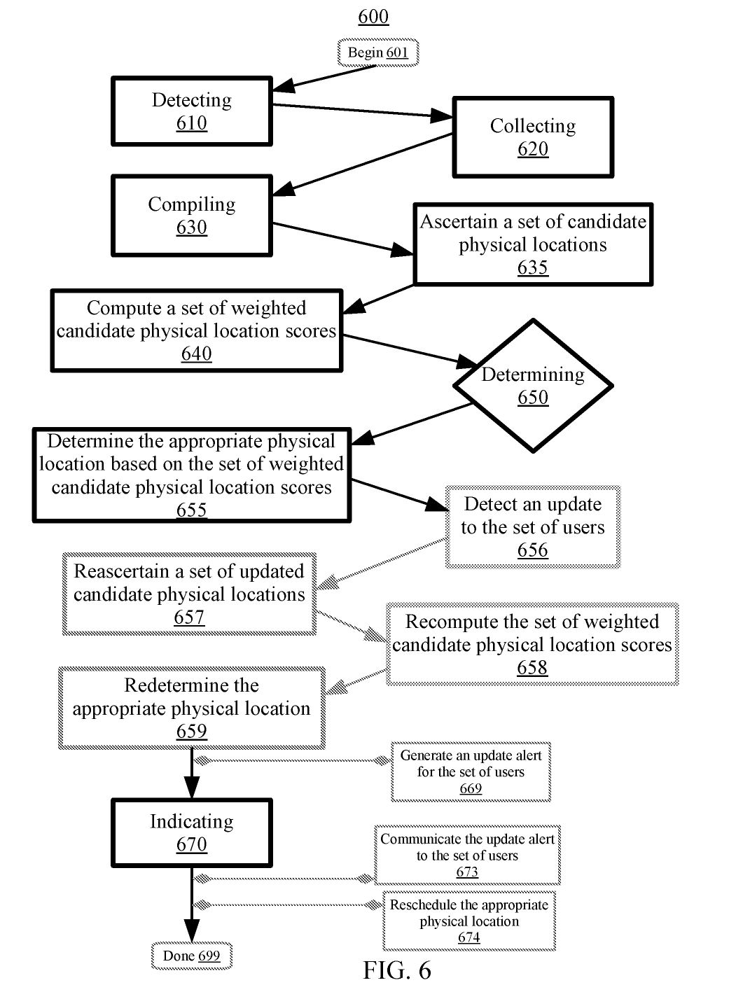

FIG. 6 is a flowchart illustrating a method 600 for physical location scheduling management, according to embodiments. Aspects of method 600 may be similar or the same as aspects of method 200/300/400/500, and aspects may be utilized interchangeably with one or more methodologies described herein. The method 600 may begin at block 601. At block 610, a meetup event having a set of parameters which includes a set of users may be detected by a physical location scheduling management engine. At block 620, a set of user accessibility profile factors for the set of users may be collected by the physical location scheduling management engine. At block 630, a set of location accessibility profile factors for a set of physical locations may be compiled by the physical location scheduling management engine. At block 650, an appropriate physical location to hold the meetup event may be determined based on both the set of location accessibility profile factors and the set of user accessibility profile factors. At block 670, the appropriate physical location to hold the meetup event may be indicated in response to determining the appropriate physical location for the meetup event.

At block 635, a set of candidate physical locations to hold the meetup event may be ascertained based on both the set of location accessibility profile factors and the set of user accessibility profile factors. Generally, ascertaining can include determining, formulating, composing, computing, or otherwise resolving a set of candidate physical locations to hold the meetup event. The set of candidate physical locations may include a group of physical meetup locations which are considered appropriate for a meetup event. The set of candidate physical locations may be ascertained based on both the set of location accessibility profile factors and the set of user accessibility profile factors. A comparison of the necessities/preferences of the attendees and the features/characteristics of the location may be carried-out, and the set of appropriate physical locations may create a set of candidate physical locations (e.g., user sensitivities A/B/C may each be paired with locations X/Y/Z to compare combinations and determine set of candidate locations). The set of candidate physical locations may occur through the filtering-out of locations which lack the needed features (e.g., a physical location which does not include a washroom may be filtered-out if the attendees require a washroom), the filtering-in of locations which have the needed or desired features (e.g., a physical location which has allergen-safe food items may be filtered-in if the attendees have allergies), or other methods of determining the set of candidate physical locations.

At block 640, a set of weighted candidate physical location scores may be computed using a set of weighting criteria with respect to the set of candidate physical locations. Generally, computing can include calculating, evaluating, formulating, or otherwise determining a set of weighted candidate physical location scores. The set of weighted candidate physical location scores may include a number or ranking which indicates how appropriate a physical location is in correlation with the user accessibility profile factors and the location accessibility profile factors. A physical location may be assigned a tag or a coefficient based on how appropriate the location may be for a meetup event. A location which meets several accessibility requests may have a higher score or ranking (e.g., best, 10/10, #1) while a location which does not meet as many requests may have a lower score or ranking (e.g., 2/10, #10). The set of weighted candidate physical location scores may be computed using a set of weighting criteria. More important criteria (e.g., serious health matters, essential attendees) may be weighted more heavily while less important criteria (e.g., preferences/desires, less essential attendees) may be weighted less heavily. The weighting criteria may be based on an organizational hierarchy (e.g., requirements/preferences of the president of a company may be more heavily weighted than requirements/preferences of an ordinary worker).

At block 655, the appropriate physical location to hold the meetup event may be determined based on the set of weighted candidate physical location scores. Generally, determining can include computing, calculating, formulating, generating, or otherwise ascertaining the appropriate physical location to hold the meetup event. The determination of the appropriate physical location may be based on a calculation or evaluation the set of weighted candidate physical location scores. Physical locations may be ranked or ordered based on their weighted scores. A location which has a higher weighted candidate physical location score may be chosen as the appropriate physical location to hold the meetup as described herein. Physical locations may be placed in designated tiers based on their weighted candidate physical location scores, and an associated-user may select a physical location from the tiers (e.g., an associated-user may select the best options from the first tier, an associated-user may select options from lower tiers if unhappy with the options on the first tier).

Consider the following example. A corporation is planning a major conference with attendees from multiple branch locations using a physical location scheduling management engine. A set of candidate physical locations to hold the conference may be ascertained based on both the set of user accessibility profile factors and the set of location accessibility profile factors. The keynote speaker may require a projector screen for a presentation (e.g., technology factor). There may be multiple (e.g., four) branches of the corporation, and attendees may be located at opposite ends of the country. The attendees may wish to select a location such that all attendees travel a relatively equal distance (e.g., distance factor). The conference may include a luncheon. An assistant of a branch manager may request a location with multiple vegetarian lunch options (e.g., nutrition factor). The first possible location may be a hotel with a projector screen and a vegetarian menu, but may require a significantly longer travel time for two of the branches. The second possible location may be a restaurant with an equal travel time for all attendees and a vegetarian menu, but no projector screen. The third possible location may be a university building which has an equal travel time for all branches and a projector screen but no vegetarian menu. Each user accessibility profile factor may be compared with each location accessibility profile factor to ascertain the set of candidate physical locations (e.g., technology factor/hotel, distance factor/hotel, nutrition factor/hotel, technology factor/restaurant, distance factor/restaurant, nutrition factor/restaurant, technology factor/university, distance factor/university, nutrition factor/university).

A set of weighted candidate physical location scores may be computed for the set of candidate physical locations. The keynote speaker may be the most important attendee of the meeting, so all locations which include the projector screen may be highly ranked (e.g., awarded ten points). The distance factor may be important although not as important as the projector screen. All candidate locations which are an equal distance from the branches may be moderately ranked (e.g., awarded five points). The assistant for the branch manager may not be essential to the meeting, so the menu request may be lowly ranked (e.g., awarded two points). The set of candidate locations may be separated into three tiers based on their weighted scores (e.g., first tier containing university and hotel, second tier containing restaurant). The associated-user (e.g., company owner, keynote speaker, administrative assistant) may select a candidate location from the first tier of options. The associated-user may select the university building as an appropriate location due to the projector screen and travel time. Other methods of determining the appropriate physical location using a set of candidate physical locations may also be possible.

At block 656, an update to the set of users of the set of parameters of the meetup event may be detected. The physical location scheduling management engine may perform the detecting. Generally, detecting can include identifying, distinguishing, sensing, discovering, or otherwise recognizing an update to the set of users. The update to the set of users of the set of parameters of the meetup event may include a modification or change to the group of invitees or attendees (e.g., an invitee is added, an invitee is subtract, an attendee can no longer attend the meetup), the set of user accessibility profile factors of the invitees or attendees (e.g., an invitee becomes ill, an invitee decides to remotely attend the meetup), the available physical locations (e.g., a physical location is no longer available), or other changes with respect to the set of parameters of the meetup event.

At block 657, a set of updated candidate physical locations to hold the meetup event may be reascertained. The set of updated candidate physical locations may be reascertained in response to the update to the set of users of the set of parameters of the meetup event. Generally, reascertaining can include redetermining, reformulating, or otherwise resolving a set of updated candidate physical locations to hold the meetup event. The set of updated candidate physical locations may include the same or a different set of candidate physical locations which are deemed appropriate for the meetup event. The set of updated candidate physical locations may be reascertained based on both the set of location accessibility profile factors and the set of user accessibility profile factors. The set of location accessibility profile factors and the set of user accessibility profile factors may be compared as described herein.

At block 658, the set of weighted candidate physical location scores may be recomputed using the set of weighting criteria with respect to the set of updated candidate physical locations. Generally, recomputing can include recalculating, reevaluating, redeterminating, or otherwise reformulating the set of weighted candidate physical location scores. The set of weighted candidate physical location scores may be recomputed for the set of updated candidate physical locations based on the set of weighting criteria (as described herein) to determine an appropriate physical location for the meetup event.

At block 659, the appropriate physical location to hold the meetup event may be redetermined based on the set of weighted candidate physical location scores. Generally, redetermining can include recalculating, reformulating, reascertaining, or otherwise regenerating the appropriate physical location to hold the meetup event (e.g., making a second appropriate physical location determination in response to making a first appropriate physical location determination). The appropriate physical location to hold the meetup event may be determined based on the set of weighted candidate physical location scores for the set of updated candidate physical locations as described herein.

Consider the following example. The corporation described herein may have determined the university building as the appropriate location for their conference. Another speaker may decide to attend the conference. The physical location scheduling management engine may detect an update to the set of users (e.g., adding the second speaker to the list of attendees). The new speaker may have difficulty walking up flights of stairs due to an injury and may require a location which has an elevator. A set of updated candidate physical locations may be reascertained based on the new attendee and their elevation factor. The elevation factor may be considered with respect to each of the candidate locations (e.g., elevation factor/hotel, elevation factor/restaurant, elevation factor/university). The set of weighted candidate physical location scores may be recomputed. The university building may not have an elevator, but the hotel and restaurant may. The speaker may be essential to the conference, so her preferences may be heavily weighted (e.g., awarded eight points). The appropriate physical location for the conference may be redetermined based on the set of weighted candidate physical scores for the updated set of candidate locations. The hotel may be determined as the appropriate physical location for the conference. Other methods of redetermining an appropriate physical location based on an update to the set of users may also be possible.

In embodiments, an update alert for the set of users may be generated by the physical location scheduling management engine at block 669. The update alert may be generated in response to redetermining the appropriate physical location for the meetup event. Generating may include creating, providing, delivering, or otherwise producing an update alert for the set of users. The update alert may include an indication of a change in location of the meetup, an indication of a lack of change in location of the meetup, an indication of a change in a temporal factor of a meetup, an indication of a lack of change in a temporal factor of a meetup, or other updates to a meetup event. The update alert may include a text message, an email, an automated phone call, an updated post in a social networking group, or the like.

In embodiments, the update alert may be communicated to the set of users by the physical location scheduling management engine at block 673. Communicating can include sending, transmitting, routing, publishing, or otherwise conveying the update alert to the set of users. The communication of the update alert may occur through changing the color of an email, flashing the updated post on the group page, changing the font of a text message, or other update alerts. Users may be prompted to indicate that the post was viewed (e.g., clicking a button, replying “confirm” to a text message).

In embodiments, the appropriate physical location to hold the meetup event may be rescheduled at block 674. The rescheduling may occur in response to redetermining the appropriate physical location for the meetup event. Rescheduling can include resending, replanning, rearranging, relocating, or otherwise reorganizing the appropriate physical location to hold the meetup event. The rescheduling may occur in an automated fashion without manual intervention by the physical location scheduling management engine. Rescheduling may include sending a message to an external system (e.g., campus room registry, third-party scheduling system) which organizes physical locations for meetup events as described herein. Rescheduling may include sending a message to all attendees of a meetup event (e.g., indicating the meetup on the calendar application of all attendees) as described herein.

Consider the following example. The corporation described herein may have determined the hotel as the appropriate physical location for the conference based on the updated set of users. An update alert may be generated for the set of users to indicate a location change from the university to the hotel. The update alert may be communicated to the attendees of the conference through a post on their group webpage. The post may flash different colors to catch the attention of the users, and the location (e.g., “hotel”) may be in a larger font. The attendees may be asked to like the post so the corporation knows everyone has seen the location change. The appropriate physical location may be rescheduled in an automated fashion. The physical location scheduling management engine may indicate the conference and the location of the hotel in the calendar application of the keynote speakers. The physical location scheduling management engine may reserve the hotel conference room via the room scheduling program of the hotel without manual intervention (e.g., a member of the corporation calling the hotel to schedule/booking online). Other methods of generating and communicating an update alert may also be possible.

Method 600 concludes at block 699. Aspects of method 600 may provide performance or efficiency benefits for physical location scheduling management. Aspects may save resources such as network bandwidth, time, processing, or memory. As an example, the automatic detection of an update to the set of users of the meetup event and the subsequent recomputing and redetermining may save processing time. When an update to the set of users is detected, the physical location scheduling management engine may automatically redetermine a set of candidate physical locations for the meetup event based on the update. This may prevent an associated-user from manually searching for physical locations for a meetup event based on the set of users. Other examples of saving processing time may also be possible.

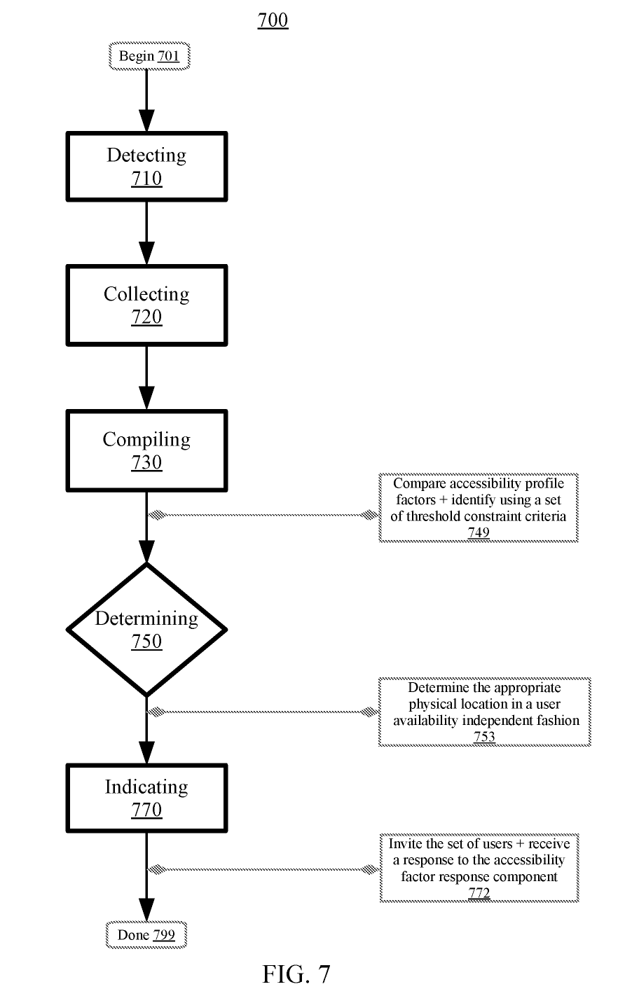

FIG. 7 is a flowchart illustrating a method 700 for physical location scheduling management, according to embodiments. Aspects of method 700 may be similar or the same as aspects of method 200/300/400/500/600, and aspects may be utilized interchangeably with one or more methodologies described herein. The method 700 may begin at block 701. At block 710, a meetup event having a set of parameters which includes a set of users may be detected by a physical location scheduling management engine. At block 720, a set of user accessibility profile factors for the set of users may be collected by the physical location scheduling management engine. At block 730, a set of location accessibility profile factors for a set of physical locations may be compiled by the physical location scheduling management engine. At block 750, an appropriate physical location to hold the meetup event may be determined based on both the set of location accessibility profile factors and the set of user accessibility profile factors. At block 770, the appropriate physical location to hold the meetup event may be indicated in response to determining the appropriate physical location for the meetup event.

In embodiments, comparing and identifying may occur at block 749. The set of location accessibility profile factors and the set of user accessibility profile factors may be compared to determine the appropriate physical location to hold the meetup event. Generally, comparing can include contrasting, evaluating, analyzing, correlating, or otherwise examining the set of user accessibility profile factors and the set of user accessibility profile factors as described herein. The appropriate physical location may be identified based on the appropriate physical location achieving a set of threshold constraint criteria for the set of user accessibility profile factors. Generally, identifying can include determining, extracting, ascertaining, or otherwise selecting the appropriate physical location. The appropriate physical location may achieve a set of threshold constraint criteria for the set of user accessibility profile factors. Achieving a set of threshold constraint criteria may include fitting acceptably within the constraints of the user accessibility profile factors (e.g., every user accessibility profile factor has been accounted for, 80% of the user accessibility profile factors have been met, 3/5 of the requirements of the attendees have been achieved). A physical location which meets all requirements and preferences of the set of users may not exist or be available. The appropriate physical location for the meetup event may be selected based on meeting the requirements of the set of users (e.g., health issues/concerns are taken into account) but not meeting all the preferences of the set of users (e.g., preferences/unnecessary accommodations not entirely considered).

Consider the following example. A university community service club may be planning their monthly meeting using a physical location scheduling management engine. The set of location accessibility profile factors and the set of user accessibility profile factors may be collected and compared to determine an appropriate physical location for the club meeting. The president of the club may be confined to a wheelchair and may need an elevator or ramp for any location which is not on the ground floor. The club advisor may request a location which is within a five minute walk from her office. Three of the club members may be giving separate presentations at the meeting and may need a television screen. A physical location may be needed which has a television screen, is accessible by elevator or ramp, and is within five minutes from the office of the advisor. A physical location on the university campus which meets these requirements may not exist. A study room on the first floor of the library may meet the requirements within a threshold constraint criteria (e.g., 50% of the attendees must have their requirements/requests met). The study room in the library may be on the ground floor and may have a television screen, but may be more than a five minute walk from the office of the advisor. The study room of the library may fulfill the requests of 4 out of 5 of the attendees, which exceeds the 50% threshold constraint criteria. The study room in the library may be identified as the appropriate physical location for the community service club meeting. Other examples of identifying the appropriate physical location based on a set of threshold constraint criteria may also be possible.

In embodiments, the appropriate physical location to hold the meetup event may be determined at block 753. The appropriate physical location may be determined in a user availability independent fashion with respect to a set of user availability factors of the set of users. Generally, determining can include computing, formulating, generating, or otherwise ascertaining the appropriate physical location. The user availability independent fashion may include the determining of a physical location and temporal feature for the physical location (e.g., a time period for which the location is available) for a meetup without regard for user availability (e.g., choosing the location in advance of/independent of the time/convenience of users). The appropriate physical location may be determined in a user availability independent fashion to streamline determination of the appropriate physical location. The appropriate physical location may be more important than user availability and may be difficult to determine based on user availability. The determination of the appropriate physical location in a user availability independent fashion may allow for a larger set of candidate physical locations (e.g., available meetup locations).

Consider the following example. A baseball team may be planning a practice using a physical location scheduling management engine. The players on the team may have various busy schedules and accessibility considerations, and it may be difficult to choose a physical location and temporal feature for practice which fits the schedule of every player. The appropriate physical location and time for practice may be determined without collecting a set of user accessibility profile factors for the players on the baseball team. As an example, the calendar application of one team member may indicate a doctor appointment on June 3. Another team member may live significantly farther north than the rest of his teammates and may prefer that practices be held in a central state location as opposed to a more southern location. A baseball field which is located in the southern part of the state may be automatically chosen as the appropriate location, and the practice may be automatically scheduled for June 3. The selected baseball field may be the only field at which this team is able to practice. The physical location (e.g., baseball field) may be more important than the distance from one player or the calendar schedule of another. There may be no physical locations which are closer to that player. June 3 may be the only day during which the field is available. Determining this particular field as the appropriate location in a user availability independent fashion may streamline determination of the appropriate physical location. Other methods of determining a location in a user availability independent fashion may also be possible.

In embodiments, inviting and receiving may occur at block 772. The set of users may be invited to the meetup event. The invitation may include an accessibility factor response component. Inviting may include sending, publishing, or otherwise transmitting. The invitation may include an email, a text message, a webpage post, or other methods of invitation. The invitation may include a component which allows users to indicate a user accessibility profile factor (e.g., a user may indicate a nut allergy, a user may respond that they require access to a washroom). The response component may be an electronic RSVP, a dropdown menu, boxes which can be checked, an area to type in a comment, or other response components. A response to the accessibility factor response component may be received from the set of users of the meetup event. Generally, receiving can include collecting, processing, gathering, obtaining, or otherwise acquiring a response to the accessibility response component from the set of users. The response may be in the form of an RSVP, a selection from a dropdown menu, checked boxes, a comment, or other responses. The response may indicate the set of user accessibility profile factors for the set of users as described herein. The response may be received to collect the set of user accessibility profile factors for the set of users.

Consider the following example. A group of friends may be planning a dinner party using a physical location scheduling management engine. An invitation (e.g., post to a group webpage) may be sent to each of the friends which includes an accessibility factor response component. The accessibility factor response component may be in the form of a comment section underneath the post. Each of the friends may type their accessibility profile factors in the comments section. As an example, one of the friends may be a vegetarian, and may indicate this by typing a comment (e.g., “I am a vegetarian”). The comment may be received by the physical location scheduling management engine. The nutrition factor (e.g., vegetarian) of the first friend may be indicated. The invitation may be an email and the accessibility factor response component may be in the form of boxes that can be checked off. The first friend may check off a box to indicate her nutrition factor (e.g., box indicating dietary concerns, box indicating vegetarian). Another friend may have seasonal allergies, and may check off a box to indicate an environmental sensitivity factor or an indoor-outdoor factor (e.g., box indicating seasonal allergy, box indicating a request to eat indoors). The nutrition factor of the first friend and the environmental sensitivity and indoor-outdoor factors of the second friend may be indicated by the physical location scheduling management engine. Other examples of using an invitation with an accessibility factor response component may also be possible.

Method 700 concludes at block 799. Aspects of method 700 may provide performance or efficiency benefits for physical location scheduling management. Aspects may save resources such as network bandwidth, time, processing, or memory. As an example, processing time may be saved through the determination of an appropriate physical location in a user availability independent fashion. An appropriate physical location may be determined without regard for user availability in order to streamline physical location scheduling. This may take less processing time than searching for an appropriate physical location while taking into account the availability of the set of users. Other examples of saving processing time may also be possible.

In addition to embodiments described above, other embodiments having fewer operational steps, more operational steps, or different operational steps are contemplated. Also, some embodiments may perform some or all of the above operational steps in a different order. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for physical location scheduling management, the method comprising:
detecting, by a physical location scheduling management engine, a meetup event having a set of parameters which includes a set of users;
collecting, by the physical location scheduling management engine, a set of user accessibility profile factors for the set of users, wherein the set of user accessibility profile factors comprises a technology factor, a distance factor, an elevation factor, a personal room factor, an indoor-outdoor factor, an access clearance factor, a computing configuration factor, an environmental sensitivity factor, a nutrition factor, and an illness status factor;
compiling, by the physical location scheduling management engine, a set of location accessibility profile factors for a set of physical locations;
ascertaining, based on both the set of location accessibility profile factors and the set of user accessibility profile factors, a set of candidate physical locations to hold the meetup event;
computing, using a set of weighting criteria with respect to the set of candidate physical locations, a set of weighted candidate physical location scores;
determining, based on both the set of location accessibility profile factors and the set of user accessibility profile factors, an appropriate physical location to hold the meetup event;
determining, based on the set of weighted candidate physical location scores, the appropriate physical location to hold the meetup event;
detecting, by the physical location scheduling management engine, an update to the set of users of the set of parameters of the meetup event;
reascertaining, in response to the update to the set of users of the set of parameters of the meetup event based on both the set of location accessibility profile factors and the set of user accessibility profile factors, a set of updated candidate physical locations to hold the meetup event;
recomputing, using the set of weighting criteria with respect to the set of updated candidate physical locations, the set of weighted candidate physical location scores;
redetermining, based on the set of weighted candidate physical location scores, the appropriate physical location to hold the meetup event;
generating, by the physical location scheduling management engine in response to redetermining the appropriate physical location for the meetup event, an update alert for the set of users;
indicating, in response to determining the appropriate physical location for the meetup event, the appropriate physical location to hold the meetup event;
communicating, by the physical location scheduling management engine, the update alert to the set of users; and
rescheduling, in an automated fashion without manual intervention by the physical location scheduling management engine in response to redetermining the appropriate physical location for the meetup event, the appropriate physical location to hold the meetup event.
